(19) United States
(12) Patent Application Publication
(10) Pub. No.: US 2009/0102645 A1
(43) Pub. Date: Apr. 23, 2009

(54) Adding social networking to devices

(76) Inventor: Richard D. Borovoy, Boston, MA (US)

Correspondence Address: FISH & RICHARDSON PC, P.O. BOX 1022, MINNEAPOLIS, MN, 55440-1022, US

(21) Appl. No.: 11/975,948

(22) Filed: Oct. 23, 2007

(51) Int. Cl. G08B 1/08

(52) U.S. Cl. 340/540

(57) ABSTRACT

A communication interface of a device communicates with a personal electronic device, and a processor associated with the communication interface automatically directs the personal electronic device, through the communication interface, either to operate in a first mode in which the personal electronic device interacts with a wearer of the personal electronic device or to operate in a second mode in which the wearable personal electronic device interacts with a person other than the wearer, based on how the wearable device is being used.

### BACKGROUND

This disclosure relates to adding social networking to devices.

Devices designed to facilitate social network include the wearable tag (or badge) developed by nTAG Interactive Corporation, which can be worn, for example, by an attendee at a convention and electronically communicates with tags worn by other attendees, for example, when two attendees face each other. Examples of such social networking tags and their uses are described in U.S. patent application Ser. Nos. 10/396,064, filed Mar. 24, 2003, 10/729,696, filed Dec. 5, 2003, 11/069,716, filed Feb. 28, 2005, 11/359,878, filed Feb. 22, 2006, and 11/397,032, filed Mar. 31, 2006, all incorporated here by reference.

### SUMMARY

In general, in one aspect, a communication interface of a device communicates with a personal electronic device, and a processor associated with the communication interface automatically directs the personal electronic device, through the communication interface, either to operate in a first mode in which the personal electronic device interacts with a wearer of the personal electronic device or to operate in a second mode in which the wearable personal electronic device interacts with a person other than the wearer, based on how the wearable device is being used.

Implementations may include one or more of the following features. The communication interface and the processor include a module to be coupled to the personal electronic device. A sensor detects how the personal electronic device is being used. The sensor includes an electronic device to generate signals in response to an external event indicative of a change in how the wearable device is being used. The sensor includes an accelerometer. The processor also receives a signal from the personal electronic device through the communication interface indicating how the personal electronic device is being used. A second communication interface communicates with another apparatus. The second communication interface includes a radio transceiver. The second communication interface has a limited directionality and is oriented to transmit and receive signals in a direction generally orthogonal to a graphic display of the personal electronic device when the apparatus is mechanically coupled to the personal electronic device.

A surface accommodates a printed label. The surface is positioned to be visible to a viewer of a graphic display on the personal electronic device when the apparatus is mechanically coupled to the personal electronic device. The surface is positioned not to be visible to the wearer of the personal electronic device when a graphic display of the personal electronic device is visible to the wearer. The surface is also positioned to be visible to a viewer of a graphic display of the personal electronic device when the viewer is other than the wearer. A first graphic display is positioned to be visible to a viewer of second a graphic display on the personal electronic device when the apparatus is physically coupled to the personal electronic device. The device includes a network communication interface. A coupling mechanically couples the device to the personal electronic device. An element of the device makes the personal electronic device wearable. The element to make the electronic device wearable includes an extendable lanyard, and how the device is being used includes an amount to which the lanyard is extended.

Detecting how the personal electronic device is being used includes detecting whether the wearer is interacting with the wearable personal electronic device. Detecting how the personal electronic device is being used includes detecting whether the person other than the wearer is interacting with the wearable personal electronic device. Detecting how the personal electronic device is being used includes receiving a signal from the personal electronic device through a communication interface. Detecting how the personal electronic device is being used includes receiving a communication from a third electronic device. The electronic device uses a network communication interface of the personal electronic device.

In general, in one aspect, an add-on device includes a mechanical coupling to couple to a portable personal electronic device that includes a display and a communication port to carry communications between the add-on device and the portable personal electronic device. The communications relate to use of the electronic device and its display for social networking when the electronic device is being worn.

Other features and advantages of the invention will be apparent from the description and the claims.

### DESCRIPTION

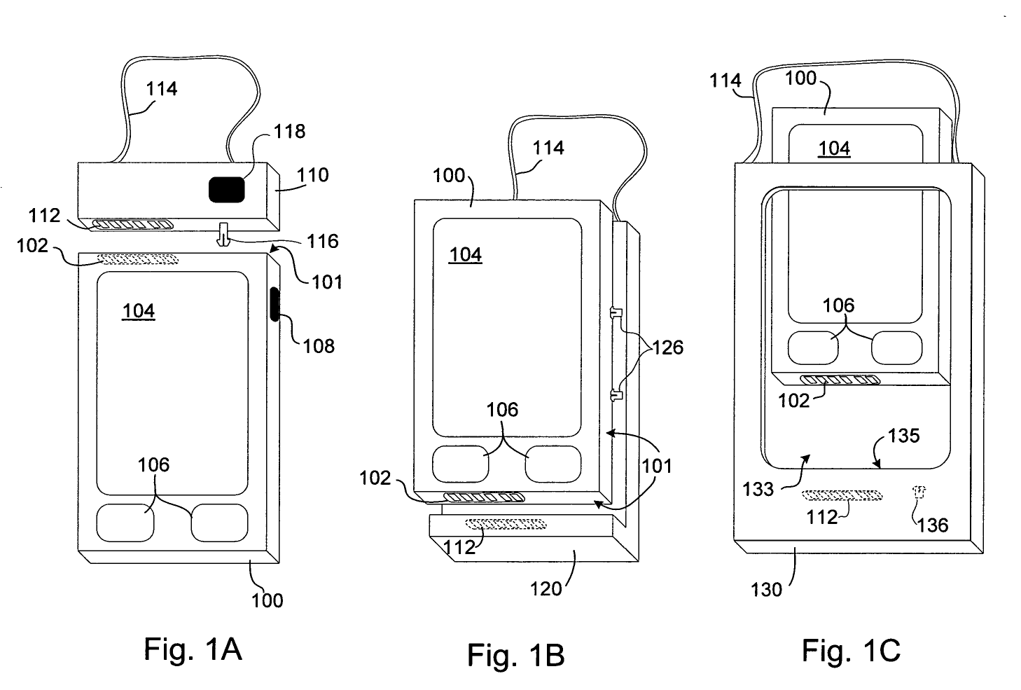

FIGS. 1A, 1B, 1C, 6A, and 6B are isometric views of tag modules and electronic devices.

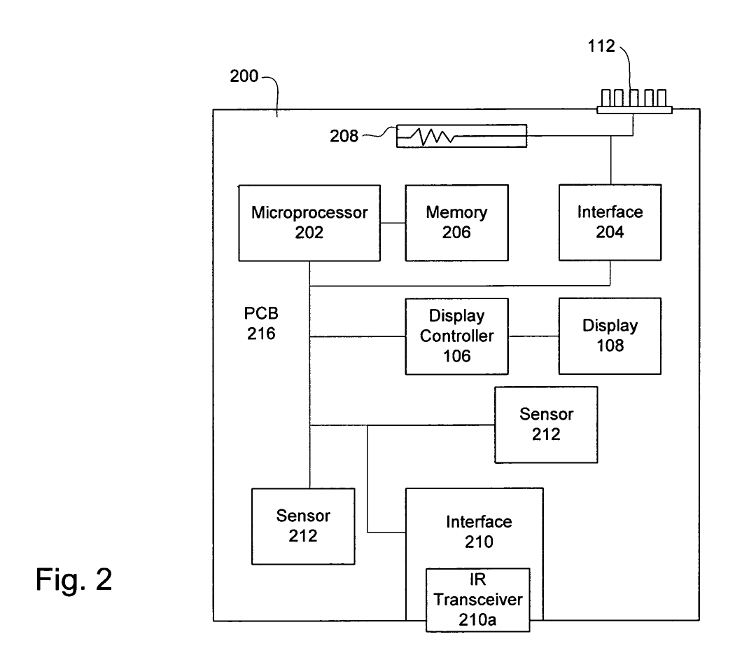

FIG. 2 is a block diagram.

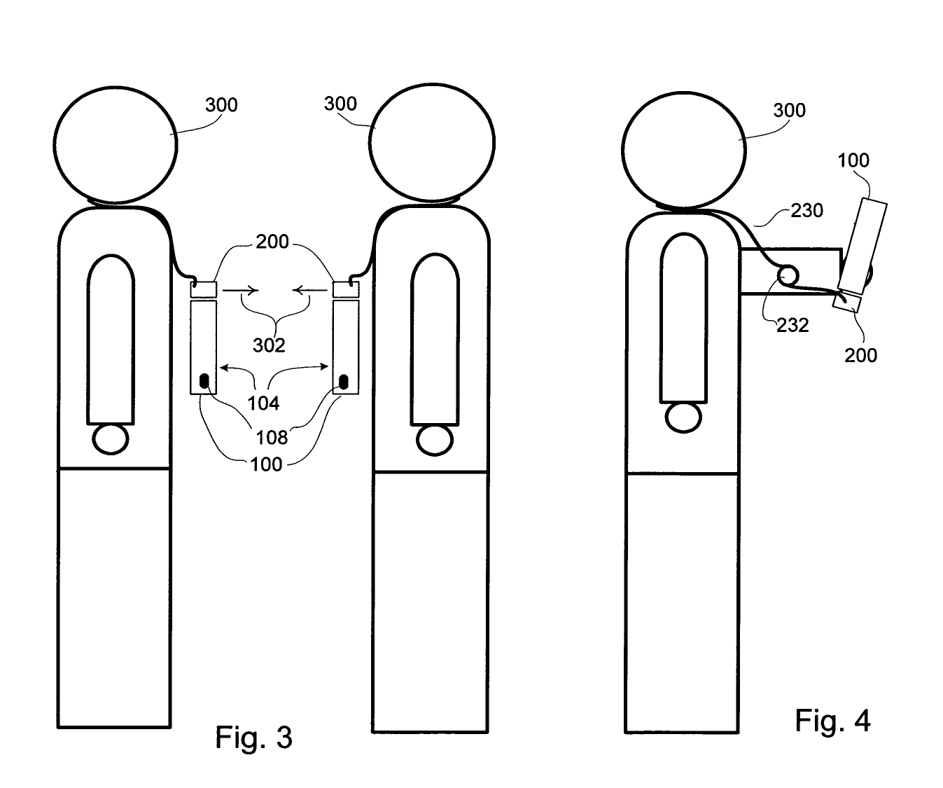

FIG. 3 is a side view of two users with wearable devices and tag modules.

FIG. 4 is a side view of one user with a wearable device and tag module.

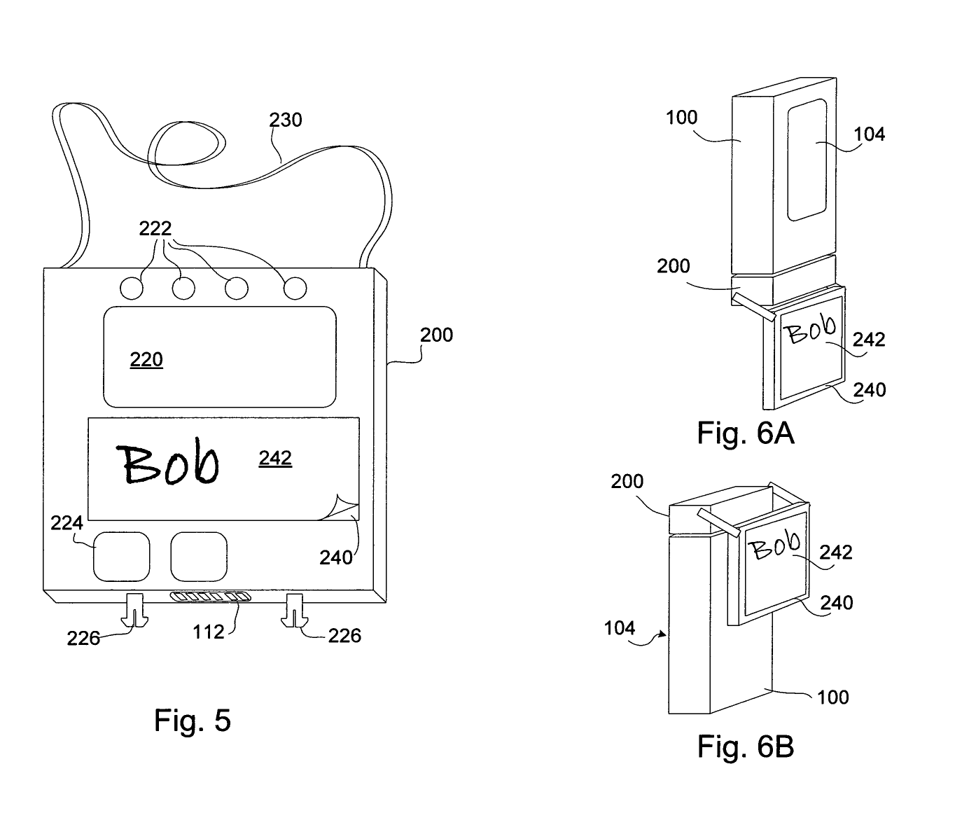

FIG. 5 is an isometric view of a tag module.

Attendees at conferences and other events often carry small personal electronic devices, such as personal digital assistants, smart phones, and music players. By attaching an electronic accessory module, as shown, for example, in FIGS. 1A-1C, to such an electronic device, an enhanced device is formed that is able to operate as a social networking tag.

In some examples, as shown in FIG. 1A, the electronic accessory module 110 is a compact module that attaches to one end 101 of a personal electronic device 100 effectively extending its length. The device 100 has a data connector 102, a screen 104, and user inputs 106, such as buttons or touch sensors. In some examples, the accessory module 110 includes an infrared (IR) transceiver 118 or other local wireless communication interface, which supplements or replaces an interface 108 included in the electronic device 100, for example, by facing in a different direction or having a different range.

In some examples, as shown in FIG. 1B, an accessory module 120 is positioned on the back of the device 100, in some cases wrapping around one or more ends or side walls 101 of the device 100, for example, to reach the data connector 102.

In some examples, as shown in FIG. 1C, an accessory module 130 is larger than the personal electronic device 100 in at least some dimensions and includes a cavity 133 into which the device 100 is inserted. The cavity 133 includes an opening or window 135 through which the screen 104 and inputs 106 of the device 100 are accessible.

In some examples, the accessory modules 110, 120, and 130 each include a data connector 112 for electronically coupling to the data connector 102 on the personal electronic device 100 when the electronic device 100 and accessory module 110, 120, or 130 are mechanically coupled. An accessory module may also use a wireless interface to communicate with the personal electronic device 100, instead of or in addition to the electronic connection. In some examples, the accessory modules 110, 120, and 130 each include an attachment 114 that allows the user to wear the personal electronic device 100, with the module 110, 120, or 130 attached, as one would wear a name tag. The attachment 114 is shown as a lanyard, but could also be a belt clip, pin, or any other mechanism that allows a user to wear the enhanced device. In some examples, the modules 110, 120, and 130 include a mechanical coupling feature 116, 126, 136 to connect to the personal electronic device 100. The coupling feature 116, 126, 136 can have any suitable form, for example, hooks, snaps, magnets, or hook-and-loop pads. In some examples, there is no wired or mechanical connection between the electronic device 100 and the accessory module 110, 120, or 130. Instead, a wireless data connection is used, and the accessory module is kept out of the way, such as in the user's bag or pocket. The attachment 114 may be provided by the electronic device 100 itself or by an additional part, such as a lanyard with a clip

Each of the accessory modules 110, 120, and 130 may have an electronic design as shown in FIG. 2, for example. When we refer to the module 200 in FIG. 2, this may include any of the modules 110, 120, and 130 in FIGS. 1A-1C. The module 200 includes a processor 202, a communications interface 204, and a memory 206 mounted on one or more printed circuit boards (PCBs) 216. The communications interface 204 may include the electronic data connection 112, a wireless interface 208, or both, as mentioned above. In some examples, the module 200 includes a second communications interface 210, e.g., the IR transceiver 118, for communicating with other similar modules and sensors 212 for detecting how the device 100 is being used. Different detectable modes of use include, for example, allowing the device 100 to hang around the user's neck for viewing by others, or turning the device 100 upside-down so that the user can view it directly, as discussed below. Sensors 212 may include accelerometers, gyroscopes, light sensors, and orientation sensors.

When the module 200 is coupled to an electronic device 100, the module 200 uses a combination of its on-board electronics and those of the device 100 to provide new features to the device 100. This enables the user to use the device 100 for social networking, for example, in the ways that the user can use the interactive tags mentioned previously. For example, a user can be informed of similarities between himself and another tag wearer, the user's actions can be tracked and rewarded, and the user can receive messages and provide feedback about his activities at the event. The social networking features that can be provided include all of those described in the identified patent applications.

The module 200 allows the device 100 to operate in new modes. That is, electronic devices 100 such as PDAs, music players, and cellular telephones are typically “personal.” This means that the user interface of such a device is meant to enable the device to interact with a single individual. Such attributes as text size, orientation, and the type of input expected are all selected to be suitable for a user who is holding the device and looking at it from a shorter distance. Nametags, on the other hand, whether electronic or not, are meant to be read from a longer distance by people other than the wearer. The interactive tags mentioned above operate in two modes-a social mode, as shown in FIG. 3, where the user interface is configured to be read from a distance by a non-wearer, and a personal mode, as shown in FIG. 4, where each device is used by its wearer, for example, to access information about his schedule or about people he recently met.

When the module 200 is coupled to the device 100, the module enables or instructs the device to operate in the social mode through the communication interface 204. In some examples, depending on the capabilities of the device 100, operating in the social mode and switching between modes only requires loading appropriate software onto the device 100. In some examples, operating in the social mode and switching between modes uses electronics in the module 200 to provide added features to the device 100.

For example, the module can determine whether to operate in the social mode or the personal mode based on its orientation, as determined by accelerometers, gyroscopes, or other orientation sensors. If the device is right-side-up, it may be operating in its personal mode, and if it is upside down (for example, because a lanyard is attached at the bottom), it may be operating in the social mode. If the device 100 has its own sensors that can detect its orientation, the module 200 may use those, but if the device 100 lacks such sensors, then sensors 212 in the module 200 can provide this feature. The communication port 204 allows the device 100 to share orientation or other sensor information with the module 200.

In some examples, the device 100 already has two modes, and the module 200 provides an additional input to cause the device to switch between them.

Another aspect of some interactive tags is that they communicate with each other, in addition to communicating with a network. The interactive tags communicate using short-range methods such as IR or Bluetooth®. In some examples, the module 200 takes advantage of facilities already present in the device 100, if the device is able to share those facilities through the connection 204. In some examples, the module 200 provides an additional communication channel through the second communications interface 210. In some examples, personal electronic devices have directional IR ports (e.g., the port 108 in FIG. 1) located on their ends or sides, which means that they may not be able to communicate with each other when worn as name tags (see FIG. 3). To address this, the interface 210 may take the form of an IR transceiver 210a mounted on a front face of the module, for example, the IR transceiver 118 in FIG. 1A, so that when the module 200 is attached to the device 100, the IR transceiver 210a is perpendicular to the screen. When two users 300 face each other, as shown in FIG. 3 (not to scale), their screens 104 (and built-in IR ports 108) are parallel, but the transceivers 210a are aligned (arrows 302). In some examples, whether the inter-module communication interface 210 is in use is used as an input to the processor 202 to indicate that the device 100 is being used in a social mode.

In some examples, the mode in which the device is being used is sensed based on user input—if the user is providing input, the device is probably being used in a personal mode, not in a social mode. As mentioned, in some examples, mode is detected based on physical sensors that detect the position and orientation of the device, and in some examples mode is detected based on whether the module is in communication with another similar module.

In some examples, the number of features included in the module 200 varies with the number of features that may be expected to be provided by the device 100. At one extreme, if the device 100 is known or expected to have all the circuitry needed to detect its mode and operate in the social mode, the module 200 may be implemented entirely in software. In some examples, it is not known in advance which features will be available in a given electronic device 100, so the module 200 includes features that may be redundant. Extra or redundant features are deactivated to conserve power, in some examples. In some examples, extra or redundant features are used to replace or supplement features already present in the electronic device 100. In some examples, the module 200 is able to be used with a variety of different devices 100, and is equipped to identify the device 100 and provide appropriate software and data based on the identification.

In some examples, the module 200 includes additional features to supplement the features that are provided by the device 100. As shown in FIG. 5, the module 200 is equipped with a graphical display 220. This display complements the graphical display 104 of the device 100 (assuming it has one) by displaying additional information or by displaying information in a manner more easily read from a distance. The display 220 may also be, for example, any number of lights 222, such as LEDs. In some examples, the module 200 includes buttons 224 or other input devices. Such input devices are useful if, for example, the device 100 does not have inputs suitable for interacting with the interactive tag features provided by the module 200. Providing inputs 224 is also useful if the device 100 does not share information about user input with the module 200.

In some examples, the module 200 includes its own wireless communication interface for connection to a network (in addition to or as an enhancement to the interfaces 208, 210). The module 200 may share that connection with the device 100, for example, if the device 100 lacks a wireless network connection or the module's connection is in some way superior.

The module 200 also includes various physical features, also shown in FIG. 5. In some examples, a mechanical coupling 226 attaches the module 200 to the device 100 (corresponding to attachment 116, 126, 136 above). Some electronic devices include couplings in or near data connectors so that accessory devices such as module 200 may be attached mechanically as well as electronically. In some examples, specific versions of the module 200 have different couplings 226 for mating with different brands and models of devices 100. In some examples, the module 200 has a single type of coupling 226 and adapters are used to mate that coupling 226 to the different connectors found on different devices 100. Similarly, in some examples, the module 200 has one type of electrical connection 112, and the adapters have appropriate connectors to mate the module's electrical connection 112 to the different electrical connectors of different devices 100. Such an adapter may identify the device 100 to the module 200, so that the module knows what software to use, as described above.

In some examples, the attachment 114 includes a lanyard 230. The lanyard allows the electronic device 100, once coupled to the module 200, to be worn as a nametag. In some examples, as shown in FIG. 4, the lanyard is extendable or includes an extendable portion 232. An extendable lanyard allows the wearer 300 to hold the device 100 farther away while interacting with it in the personal mode. For example, if the lanyard 230 is sized to hold the device 100 at mid-chest when worn as a nametag (FIG. 3), the device 100 would be too close to the wearer's face to comfortably use it in the personal mode, so the lanyard 230 extends (FIG. 4). In some examples, the lanyard 230 includes a sensor to detect when it has been extended. This serves as an input about the mode in which the device 100 is being used so that the processor 202 can change the user interface to the appropriate mode, as discussed above. The extendable, sensor-equipped lanyard may also be added to the regular interactive tags.

In some examples, the module 200 includes a space 240 for a printed label 242. Such a label 242 is used, for example, for a printed or handwritten nametag that supplements whatever dynamic information is displayed on the screen 104. A fixed nametag label 242 frees up space on the screen 104 for displaying supplemental information, as opposed to taking up a large amount of space to display the wearer's name. In some examples, the space 240 is attached to the module 200 in such a way that the label 242 remains visible to others when the wearer is using the device in the personal mode. As shown in FIGS. 6A and 6B, the space 240 hangs from the bottom of the module 200. When the user 300 lifts the module and device and turns them to face himself, the space 240 hangs off what is now the top of the module 200, folded over the back of the device 100. The electronic display 220 on the module may be similarly attached so that it remains visible when the user is viewing the display 104 on the device 100.

Other implementations are within the scope of the following claims and other claims to which the applicant may be entitled.

What is claimed is:

1. An apparatus comprising:
a communication interface for communicating with a personal electronic device; and
a processor associated with the communication interface to automatically direct the personal electronic device, through the communication interface, either
to operate in a first mode in which the personal electronic device interacts with a wearer of the personal electronic device or
to operate in a second mode in which the wearable personal electronic device interacts with a person other than the wearer,
based on how the wearable device is being used.

2. The apparatus of claim 1 in which the communication interface and the processor comprise a module to be coupled to the personal electronic device.

3. The apparatus of claim 1 also comprising a sensor to detect how the personal electronic device is being used.

4. The apparatus of claim 3 in which the sensor comprises an electronic device to generate signals in response to an external event indicative of a change in how the wearable device is being used.

5. The apparatus of claim 3 in which the sensor comprises an accelerometer.

6. The apparatus of claim 1 in which
the processor is also to receive a signal from the personal electronic device through the communication interface indicating how the personal electronic device is being used.

7. The apparatus of claim 1 also comprising:
a second communication interface to communicate with another apparatus.

8. The apparatus of claim 7 in which the second communication interface comprises a radio transceiver.

9. The apparatus of claim 7 in which
the second communication interface has a limited directionality and is oriented to transmit and receive signals in a direction generally orthogonal to a graphic display of the personal electronic device when the apparatus is mechanically coupled to the personal electronic device.

10. The apparatus of claim 1 also comprising a surface to accommodate a printed label.

11. The apparatus of claim 10 in which
the surface is positioned to be visible to a viewer of a graphic display on the personal electronic device when the apparatus is mechanically coupled to the personal electronic device.

12. The apparatus of claim 10 in which
the surface is positioned not to be visible to the wearer of the personal electronic device when a graphic display of the personal electronic device is visible to the wearer.

13. The apparatus of claim 12 in which
the surface is also positioned to be visible to a viewer of a graphic display of the personal electronic device when the viewer is other than the wearer.

14. The apparatus of claim 1 also comprising
a first graphic display positioned to be visible to a viewer of second a graphic display on the personal electronic device when the apparatus is physically coupled to the personal electronic device.

15. The apparatus of claim 1 also comprising a network communication interface.

16. The apparatus of claim 1 also including a coupling to mechanically couple the apparatus to the personal electronic device.

17. The apparatus of claim 1 also comprising an element to make the personal electronic device wearable.

18. The apparatus of claim 17 in which
the element to make the electronic device wearable comprises an extendable lanyard, and in which
how the device is being used comprises an amount to which the lanyard is extended.

19. A method comprising:
in a first electronic device,
detecting how a personal second electronic device in digital communication with the first electronic device is being used; and
based on the detection, instructing the second electronic device either
to operate in a first mode in which the second electronic device interacts with a wearer of the second device or
to operate in a second mode in which the second electronic device interacts with a person other than the wearer.

20. The method of claim 19 in which
detecting how the second device is being used comprises detecting whether the wearer is interacting with the wearable second device.

21. The method of claim 19 in which
detecting how the second device is being used comprises detecting whether the person other than the wearer is interacting with the wearable second device.

22. The method of claim 19 in which
detecting how the second device is being used comprises receiving a signal from the second device through a communication interface.

23. The method of claim 19 in which
detecting how the second device is being used comprises receiving a communication from a third electronic device.

24. The method of claim 19 also comprising, in the first electronic device, using a network communication interface of the second device.

25. An add-on device including
a mechanical coupling to couple to a portable personal electronic device that includes a display, and
a communication port to carry communications between the add-on device and the portable personal electronic device,
the communications relating to use of the electronic device and its display for social networking when the electronic device is being worn.
